(19) United States
(12) Patent Application Publication
(10) Pub. No.: US 2012/0156412 A1
(43) Pub. Date: Jun. 21, 2012

(54) Use of Low-Temperature Foamable Epoxide Resins in Hollow Chamber Structures

(75) Inventors: Dennis BANKMANN, Duesseldorf (DE); Emilie Barriau, Laguna Niguel, CA (US); Martin Renkel, Duesseldorf (DE); Sven Wucherpfennig, Dormagen (DE); Olaf Lammerschop, Krefeld (DE); Karl Braun, Gernlinden (DE)

(73) Assignee: Henkel AG & Co. KGaA, Duesseldorf (DE)

(21) Appl. No.: 13/407,837

(22) Filed: Feb. 29, 2012

Related U.S. Application Data
(63) Continuation of application No. PCT/EP2010/061688, filed on Aug. 11, 2010.

(30) Foreign Application Priority Data
Aug. 31, 2009 (DE) 102009029030.3

(51) Int. Cl. B32B 1/08; B29C 65/02; B05D 7/22

(52) U.S. Cl. 428/35.7; 427/238; 156/287

(57) ABSTRACT

A method for reinforcing a substrate having a hollow structure or for fixing an insert in such a substrate comprises introducing a one- or two-component expandable and curable preparation based on epoxy resin into a selected part of the hollow structure to be reinforced. The preparation cures by being heated to a temperature in the range from 20 to 100° C. or above, while being expanded. An epoxy resin prepolymer and an organic ammonium carbamate, which at a temperature in the range from 20° to 100° C. or above releases at least 25% of the CO₂ bound as carbamate.

### CROSS-REFERENCE TO RELATED APPLICATIONS

This application is a continuation of International Patent Application No. PCT/EP2010/060958 filed Jul. 28, 2010, which claims priority to German Patent Application No. 10 2009 028 100.2 filed Jul. 29, 2009, the contents of both of which are incorporated herein by reference.

In the context of this invention a hollow structure is understood firstly to be a structure having more or less regularly arranged cavities, such as for example solid foams or cellular structures such as for example honeycomb structures, etc. Secondly the cavity can be a coherent volume of larger dimensions, such as for example the interior of a pipe, a hollow section or a commodity. The cavities typically have diameters in the range from 0.1 to 100 mm, in particular 1 to 30 mm. In the case of solid foams or cellular structures such as for example honeycomb structures, cells of 1 to 10 mm, in particular 1 to 5 mm diameter can occur, although larger cavities that have to be filled can also be formed by drilling. The material for these substrates can consist for example of metal, plastic, board or similar. Such substrates are used for example in transportation and in particular in shipbuilding and aircraft construction as lightweight building materials, for example for the construction of interior fittings for aircraft or ships, in particular the overhead compartments in aircraft.

The present invention uses the known effect that organic amines can reversibly absorb CO₂, forming carbamic acid, wherein the carbamic acid reacts with further amine in a self-neutralizing reaction to form an organic ammonium carbamate salt, as illustrated in the skeletal formula below. The amine that forms the carbamic acid is primary or secondary, whereas the neutralizing amine can be primary, secondary or tertiary. In the case of multifunctional amines the acid-base reaction can take place intramolecularly or intermolecularly. However, only 0.5 CO₂ equivalents can be reacted, relative to the free amine groups of the starting material.

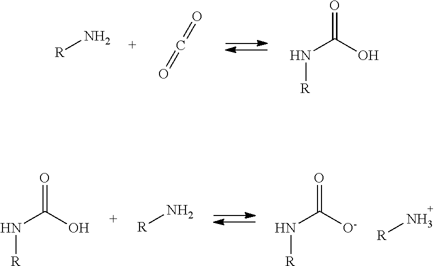

The use of such carbamates for expanding and curing epoxy resins is known from U.S. Pat. No. 3,320,187. According to this document the expanded and cured epoxy resins are used for example as fillers in the aviation industry, as thermal insulating materials or as potting materials.

The use of organic carbamates as expandable hardeners for resin systems is likewise described in U.S. Pat. No. 3,425,964. They can be used for example in the production of films, coatings or adhesives. A further application is the potting of electronic components or the use as a packaging material or insulating material. Expanded epoxy resins for example can be used for this purpose.

The present invention extends the range of applications for epoxy resins that can be expanded and cured by means of carbamates at a temperature in the range from 20 to 100° C. Higher curing temperatures are possible, but then the advantage according to the invention has less of an effect.

The present invention moreover improves the anchoring of inserts in hollow structures, which has hitherto usually been carried out by means of conventional two-component adhesives. With the present invention it is now possible to reduce the mass of the adhesive that is needed in the sense of lightweight construction, as the expanded and cured material can have a much lower density than a non-expanded adhesive.

Moreover, a further advantage of an expandable adhesive material lies in its ability to compensate for tolerances and differences in the size of the cavity by means of variable expansion, whereas in the case of a conventional, non-expandable adhesive material the amount of adhesive has to be adjusted.

In a first embodiment the present invention relates to a method for reinforcing a substrate having a hollow structure, wherein an expandable and curable preparation based on epoxy resin is introduced into a selected part of the hollow structure to be reinforced, and the preparation cures by being heated to a temperature in the range from 20° C. to 100° C. or above, preferably up to 80° C. and in particular up to 65° C., while being expanded, wherein the preparation contains at least the following components:
a) at least one epoxy resin prepolymer (wherein this term also includes the monomers, see above) having reactive epoxy groups,
b) at least one organic ammonium carbamate, preferably one that at a temperature in the range from 20 to 100° C. or above, but preferably up to 80° C. and in particular up to 65° C., releases at least 25% of the CO₂ bound as carbamate within one hour.

In a further embodiment the present invention relates to a method for fixing an insert in a substrate having a hollow structure, wherein an expandable and curable preparation based on epoxy resin is introduced into a selected part of the hollow structure in which the insert is to be fixed, the insert is introduced into the same part of the hollow structure such that the part of the insert to be fixed inside the hollow structure dips into the expandable and curable preparation at least after it is expanded and cured, and the preparation cures by being heated to a temperature in the range from 20° C. to 100° C. or above, but preferably up to 80° C. and in particular up to 65° C., while being expanded, wherein the preparation contains at least the following components:
a) at least one epoxy resin prepolymer having reactive epoxy groups,
b) at least one organic ammonium carbamate, preferably one that at a temperature in the range from 20 to 100° C. or above, preferably up to 80° C. and in particular up to 65° C., releases at least 25% of the CO₂ bound as carbamate within one hour.

According to the invention the term “organic ammonium carbamate” is understood to be a compound comprising at least one carbamate anion and at least one organic ammonium counterion.

The fact that this method results in an expanded and cured epoxy resin presupposes that the CO₂ released from the carbamate remains partly, preferably as completely as possible, embedded in the cured preparation in the form of gas-filled cavities. A foam-like structure with pores is thus obtained after curing. The fact that this can be controlled by the choice of amine is explained in more detail below.

The epoxy resin prepolymer should be at least difunctional, in other words should have at least two reactive epoxy groups, so that a polymerization reaction can take place with the amine released from the carbamate. It can be used as a monomer or as an already prepolymerized prepolymer. Both are included in this document under the term “epoxy resin prepolymers” or “epoxy resins”.

The epoxy resin prepolymers, also referred to below as “epoxy resins”, can in principle be saturated, unsaturated, cyclic or acyclic, aliphatic, alicyclic, aromatic or heterocyclic polyepoxy compounds.

Suitable epoxy resins within the context of the present invention are for example preferably selected from epoxy resins of the bisphenol A type, epoxy resins of the bisphenol S type, epoxy resins of the bisphenol F type, epoxy resins of the phenol-novolak type, epoxy resins of the cresol-novolak type, epoxidized products of numerous dicyclopentadiene-modified phenolic resins, obtainable by reacting dicyclopentadiene with numerous phenols, epoxidized products of 2,2′,6,6′-tetramethylbiphenol, aromatic epoxy resins such as epoxy resins having a naphthalene framework and epoxy resins having a fluorene framework, aliphatic epoxy resins such as neopentyl glycol diglycidyl ether and 1,6-hexanediol diglycidyl ether, alicyclic epoxy resins such as 3,4-epoxycyclohexylmethyl-3,4-epoxycyclohexane carbon/late and bis(3,4-epoxycyclohexyl)adipate and epoxy resins having a heterocyclic ring such as triglycidyl isocyanurate. In particular the epoxy resins encompass for example the reaction product of bisphenol A and epichlorohydrin, the reaction product of phenol and formaldehyde (novolak resins) and epichlorohydrin, glycidyl esters and the reaction product of epichlorohydrin and p-aminophenol.

Further polyphenols that yield suitable epoxy resin prepolymers by reaction with epichlorohydrin (or epibromohydrin) are: resorcinol, 1,2-dihydroxybenzene, hydroquinone, bis(4-hydroxyphenyl)-1,1-isobutane, 4,4′-dihydroxybenzophenone, bis(4-hydroxyphenyl)-1,1-ethane and 1,5-hydroxynaphthalene.

Further suitable epoxy prepolymers are polyglycidyl ethers of polyalcohols or diamines. Such polyglycidyl ethers derive from polyalcohols, such as for example ethylene glycol, diethylene glycol, triethylene glycol, 1,2-propylene glycol, 1,4-butylene glycol, triethylene glycol, 1,5-pentanediol, 1,6-hexanediol or trimethylolpropane.

Further preferred epoxy resins that are commercially available encompass in particular octadecylene oxide, epichlorohydrin, styrene oxide, vinyl cyclohexene oxide, glycidol, glycidyl methacrylate, diglycidyl ethers of Bisphenol A (e.g. those that are obtainable under the trade names “Epon 828”, “Epon 825”, “Epon 1004” and “Epon 1010” from Hexion Specialty Chemicals Inc., “DER-331”, “DER-332”, “DER-334”, “DER-732” and “DER-736” from Dow Chemical Co.), vinyl cyclohexene dioxide, 3,4-epoxycyclohexylmethyl-3,4-epoxycyclohexene carboxylate, 3,4-epoxy-6-methylcyclohexylmethyl-3,4-epoxy-6-methyl cyclohexene carboxylate, bis(3,4-epoxy-6-methylcyclohexylmethyl) adipate, bis(2,3-epoxycyclopentyl)ether, aliphatic, polypropylene glycol-modified epoxide, dipentene dioxide, epoxidized polybutadiene (e.g. Krasol products from Sartomer), silicone resin containing epoxy functionalities, flame-retardant epoxy resins (e.g. “DER-580”, a brominated epoxy resin of the bisphenol type, obtainable from Dow Chemical Co.), 1,4-butanediol diglycidyl ethers of a phenol-formaldehyde novolak (e.g. “DEN-431” and “DEN-438” from Dow Chemical Co.), and resorcinol diglycidyl ethers (e.g. “Kopoxite” from Koppers Company Inc.), bis(3,4-epoxycyclohexyl) adipate, 2-(3,4-epoxycyclohexyl-5,5-spiro-3,4-epoxy)cyclohexane metadioxane, vinyl cyclohexene monoxide, 1,2-epoxyhexadecane, alkyl glycidyl ethers such as for example C8-C10 alkyl glycidyl ethers (e.g. “HELOXY Modifier 7” from Hexion Specialty Chemicals Inc.), C12-C14 alkyl glycidyl ethers (e.g. “HELOXY Modifier 8” from Hexion Specialty Chemicals Inc.), butyl glycidyl ethers (e.g. “HELOXY Modifier 61” from Hexion Specialty Chemicals Inc.), cresyl glycidyl ethers (e.g. “HELOXY Modifier 62” from Hexion Specialty Chemicals Inc.), p-tert-butylphenyl glycidyl ethers (e.g. “HELOXY Modifier 65” from Hexion Specialty Chemicals Inc.), polyfunctional glycidyl ethers such as for example diglycidyl ethers of 1,4-butanediol (e.g. “HELOXY Modifier 67” from Hexion Specialty Chemicals Inc.), diglycidyl ethers of neopentyl glycol (e.g. “HELOXY Modifier 68” from Hexion Specialty Chemicals Inc.), diglycidyl ethers of cyclohexane dimethanol (e.g. “HELOXY Modifier 107” from Hexion Specialty Chemicals Inc.), trimethylolethane triglycidyl ethers (e.g. “HELOXY Modifier 44” from Hexion Specialty Chemicals Inc.), trimethylolpropane triglycidyl ethers (e.g. “HELOXY Modifier 48” from Hexion Specialty Chemicals Inc.), polyglycidyl ethers of an aliphatic polyol (e.g. “HELOXY Modifier 84” from Hexion Specialty Chemicals Inc.), polyglycol diepoxide (e.g. “HELOXY Modifier 32” from Hexion Specialty Chemicals Inc.), bisphenol F epoxides (e.g. “EPN-1138” or GY-281″ from Huntsman Int. LLC), 9,9-bis-4-(2,3-epoxypropoxy)phenyl fluorenone (e.g. “Epon 1079” from Hexion Specialty Chemicals Inc.).

Further preferred commercially available compounds are selected for example from Araldite™ 6010, Araldite™ GY-281™, Araldite™ ECN-1273, Araldite™ ECN-1280, Araldite™ MY-720, RD-2 from Huntsman Int. LLC; DEN™ 432, DEN™ 438, DEN™ 485 from Dow Chemical Co., Epon™ 812, 826, 830, 834, 836, 871, 872, 1001, 1031 etc. from Hexion Specialty Chemicals Inc. and HPT™ 1071, HPT™ 1079 likewise from Hexion Specialty Chemicals Inc., as novolak resins also for example Epi-Rez™ 5132 from Hexion Specialty Chemicals Inc., ESCN-001 from Sumitomo Chemical, Quatrex 5010 from Dow Chemical Co., RE 305S from Nippon Kayaku, Epiclon™ N673 from DaiNipon Ink Chemistry or Epicote™ 152 from Hexion Specialty Chemicals Inc.

Furthermore, at least small proportions of the following polyepoxides can be used: polyglycidyl esters of polycarboxylic acids, for example reaction products of glycidol or epichlorohydrin with aliphatic or aromatic polycarboxylic acids such as oxalic acid, succinic acid, glutaric acid, terephthalic acid or dimeric fatty acid.

The epoxy equivalent of suitable polyepoxides can vary between 150 and 50,000, preferably between 170 and 5000. For example, an epoxy resin based on epichlorohydrin/bisphenol A that has an epoxy equivalent weight of 475 to 550 g/eq or an epoxy group content in the range from 1820 to 2110 mmol/g is suitable. The softening point determined in accordance with RPM 108-C is in the range from 75 to 85° C. Reaction products of epichlorohydrin with bisphenol A or bisphenol F are preferably used as epoxy prepolymers that are liquid at room temperature. These typically have epoxy equivalent weights in the range from approximately 150 to approximately 480.

The composition for use according to the invention can have a one-component or two-component structure. In one possible embodiment with a two-component structure, one component contains the epoxy resin prepolymer, the other component the organic ammonium carbamate. This does not necessarily have to be the case, however: if a carbamate has been shifted to a latent state by 100% loading or has a sufficiently low reactivity, it can be present in one component mixed with the epoxide. The second component can then contain a reactive amine and the carbamate would be broken down either by the heat of reaction or by heating. In order for the two components to be able to be mixed together immediately before application, both components are preferably liquid at room temperature (22° C.). For this embodiment it is therefore preferable for the preparation to contain at least one epoxy resin prepolymer that is liquid at 22° C.

In the one-component embodiment the preparation according to the invention is preferably not liquid but can rather be in a state between soft and kneadable to plastic-solid. In order to obtain a kneadable to plastic-moldable preparation, it is likewise preferably for the preparation to contain at least one epoxy resin prepolymer that is liquid at 22° C.

At the same time the viscosity of the preparation should be high enough at the expansion and curing temperature for the CO₂ that is formed to be held in the preparation at least partly and preferably as completely as possible in the form of gas bubbles. This can be achieved in that the preparation contains at least one epoxy resin prepolymer that is waxy or solid at 22° C. The preparation particularly preferably contains both an epoxy prepolymer that is liquid at 22° C. and an epoxy prepolymer that is waxy or solid at 22° C.

The preparation preferably contains 5 wt. % to 90 wt. % and in particular 20 wt. % to 80 wt. % of epoxy prepolymer, wherein this can be present as an epoxy prepolymer that is solid or waxy at 22° C., as an epoxy prepolymer that is liquid at 22° C. or as a mixture of different epoxy prepolymers.

In this description amounts given as percentages by weight should generally be understood to refer to the mass of the complete preparation, which makes up 100 percent by weight. In the case of two-component systems the figures relate to the mass of the preparation after mixing the two components.

The carbamate anion preferably has a structure according to formula (I)

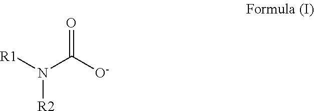

in which R1 denotes hydrogen or an organic residue and R2 represents an organic residue. Residues R1 and R2 can be identical or different if R1 does not denote hydrogen. Carbamate salts of primary amines are preferred, such that R1 preferably denotes hydrogen. Carbamate anions having a structure according to formula (II) are thus preferred:

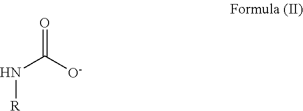

in which R denotes an organic residue. The nature of the residue R shapes the reactivity of the carbamate and of the corresponding free amine in two respects. Firstly residue R determines how readily the organic amine absorbs CO₂ to form carbamate and releases it again as the temperature rises to re-form the amine. The stability of the carbamate salt is largely determined by two factors. First of all a high basicity of the free amine leads to a highly exothermic neutralization reaction with the carbamic acid formed as an intermediate. Correspondingly, in accordance with thermodynamic principles, a high energy barrier has to be overcome in order to recover the starting materials, in other words the carbamate salt has a high thermal stability. Secondly a considerable amount of energy is necessary to overcome the Coulomb interaction energy of the carbamate salt. This effect is observed especially with small, symmetrical free amines, and it likewise brings about a high thermal stability. Suitable amines within the meaning of the present invention are those that at the desired temperature release at least 25% of the CO₂ bound as carbamate within one hour.

Secondly the nature of the residue R controls the reactivity to the epoxy resin polymer and hence the curing characteristics. Carbamates of formula (II) are preferably used in which the organic residue R can denote:

an alkyl residue or arylalkyl residue having 1 to 100 C atoms, which can carry one or more further amino or alkylamino groups which in turn can be converted into carbamate groups,

a residue of a di- or polyalkylene amine in which further amino groups can be converted into carbamate groups,

a residue of a polyalkylene glycol,

a residue of a polyglycolamine whose further amino group(s) can likewise be converted into one or more carbamate groups.

Residue R2 of formula (I) preferably has the same meaning as residue R of formula (II). If it is not hydrogen, residue R1 of the formula preferably likewise has the same meaning as residue R in formula (II).

Carbamate anions of formula (I), in which at least one of the residues R1 or R2 denotes

a residue of a polyalkylene glycol or

a residue of a polyglycolamine whose further amino group(s) can likewise be converted into one or more carbamate groups,

are particularly preferred according to the invention as they are distinguished by an improved reactivity to the epoxy resin and hence by improved curing characteristics. Carbamate anions of formula (I) in which at least one of the residues R1 or R2 denotes a residue of a polyalkylene glycol, are most particularly preferred according to the invention.

At least small proportions of carbamates of amines having two or three amino groups are used here. The crosslinking behavior and the mechanical properties of the cured preparation can be controlled in this way.

Examples of suitable amines as a base for the carbamates are: triethylenetetramine, isophorone diamine, aminoethyl piperazine, polyethylene glycol diamine, polypropylene glycol diamine and triamine (known for example as Jeffamine™ D and T), polytetrahydrophoran polyamines and polytetrahydrophoran/polypropylene glycol polyamines, polyamido amines, aryl polyamines such as for example 4,4′-diaminodiphenylmethane, alkylene polyamines such as for example polyethylene polyamines, diethylaminopropylamine, diethylenetriamine and further amines that are known to the person skilled in the art as hardeners for epoxy resins.

The organic ammonium counterion can in principle be formed from any organic amine. In terms of applicational properties it has however proved particularly advantageous according to the invention for the ammonium counterion to be formed from the same organic amine that is involved in carbamate formation.

Production methods for such carbamates are known from the documents U.S. Pat. No. 3,320,187 and U.S. Pat. No. 3,425,964 cited in the introduction.

Diamines or polyamines, some of whose amino groups have already been reacted with epoxides, such that only a proportion of the original amino groups are available for carbamate formation, can also be used. These can be produced in the manner described in WO 2007/025007, page 17, line 4 to page 19, line 25. In order to have free amino groups for carbamate formation after the reaction, however, the amines must be used in stoichiometric excess relative to the epoxy groups. Diglycidyl ethers of bisphenols, in particular of bisphenol A, are preferably used as the epoxide.

Conversely, after the partial reaction of diamines or polyamines with CO₂ to form the carbamate, it is possible, and in terms of a better control of the curing reaction even preferable, for amino groups that have not reacted to carbamate to be reacted with (preferably mono- or difunctional) epoxides before they are mixed with the bulk of the epoxide. The following skeletal formula gives an example of this:

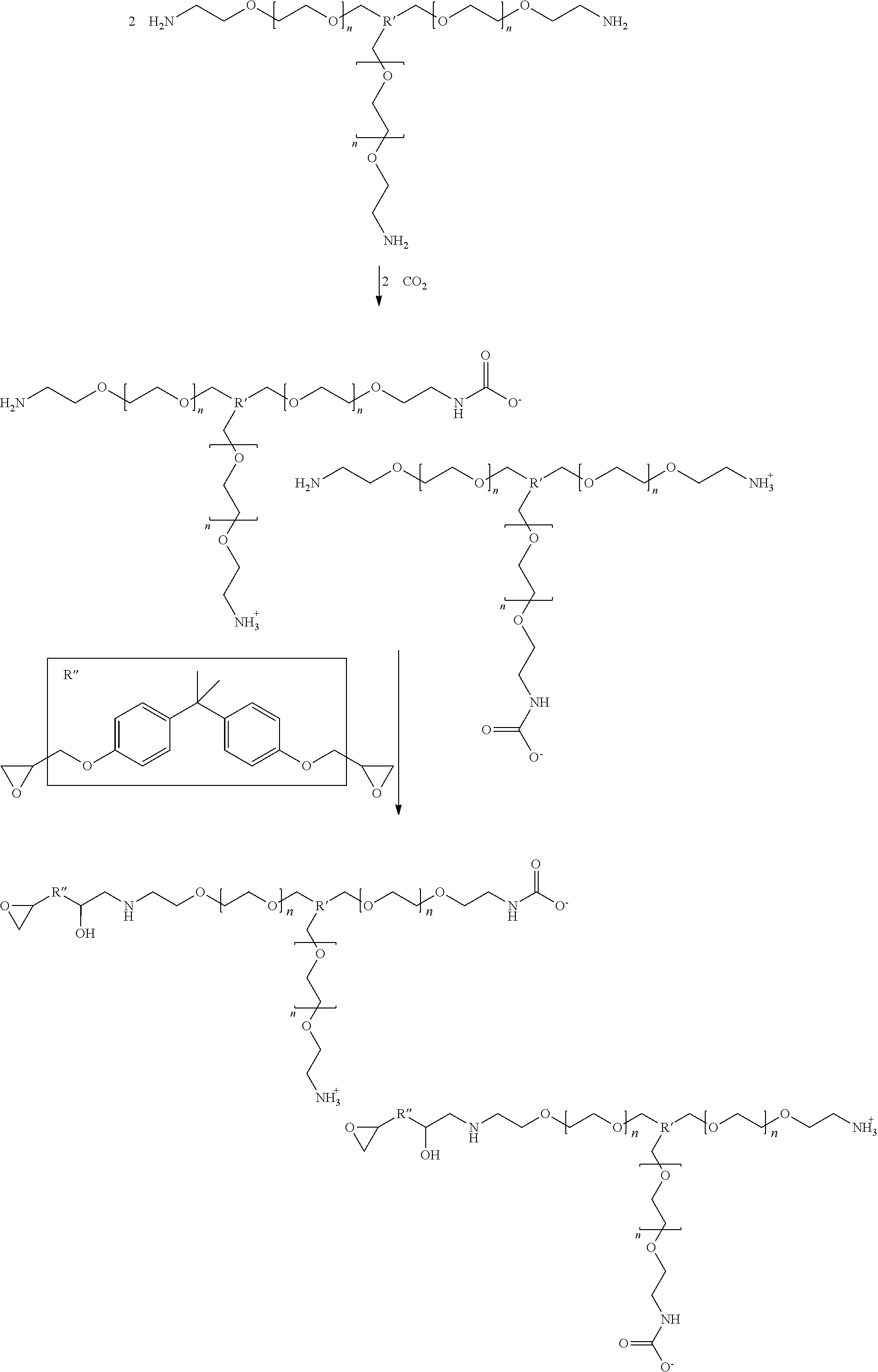

It has been found that polyfunctional amines having molar masses in the range of less than 200 often form carbamates that release only an insignificant amount of CO₂ at temperatures of 100° C. maximum and in particular 65° C. maximum. As an expansion and curing temperature of 100° C. maximum and in particular 65° C. maximum is desired within the context of the present invention (even if higher temperatures are not excluded), such amines are less suitable for the present invention. Furthermore, it has been found for example for the group of polyether amine-based hardeners such as the Jeffamine types that although amines having a molar mass above approximately 1800, particularly above 3000 and more markedly above 4000 g/mol can bind CO₂ as a carbamate as desired and release it again in the desired temperature range, these amines are often so chemically inert in respect of the epoxy resin prepolymers that a large part of the CO₂ escapes from the preparation before it is sufficiently cured to include further CO₂ in the form of gas bubbles. For the method according to the invention it is therefore particularly preferable for amines to be used to cure the epoxy resin that before formation of the carbamate have a molar mass in the range from approximately 200 to approximately 4000, preferably up to approximately 3000 and in particular up to approximately 1800 g per mol. Depending on the basicity, however, amines having a lower or higher molar mass than the aforementioned particularly preferred range can also be suitable. The group of amines that are suitable in principle generally includes those having molar masses in the range from approximately 60 to approximately 8000 g/mol.

There is also the possibility of using a mixture of two amines, such that a first carbamate having a molar mass in the range from approximately 200 to approximately 4000, preferably up to approximately 3000 and in particular up to approximately 1800 g/mol is present in carbamate form and is used for expanding the resin and a second amine that is suitable for curing at a temperature of 100° C. maximum and in particular 65° C. maximum is used for curing the epoxy resin.

In order to ensure an adequate expansion of the preparation, it must contain a minimum content of CO₂ bound as carbamate. Therefore it is preferable for the preparation to contain at least 0.5 wt. %, preferably at least 1 wt. %, relative to the complete preparation, of CO₂ bound as carbamate. The corresponding amount of carbamate can be determined from the molar mass of the amine on which the carbamate is based. The preparation preferably contains 5 to 95 wt. %, particularly preferably 10 to 60 wt. % of organic ammonium carbamate, as complete ammonium salt. In addition to the carbamate anions and the organic counterions the preparation can contain free amine molecules. Curing is generally accelerated as a result. This can be advisable in particular if the preparation is in two-component form. The content of free amine, relative to the complete preparation, can be between 0 and 90 wt. %, preferably between 1 and 60 wt. %.

The preparation can also contain impact promoters (tougheners), such as are known for epoxy adhesives. The use of impact promoters allows an improved stability of the reinforced hollow structures produced according to the invention or an improved adhesion of the inserts fixed in the hollow structures. The impact promoters can for example be rubber, in particular in the form of rubber nanoparticles, thermoplastic polymers such as for example thermoplastic polyurethanes, core-shell particles having an organic polymer shell and an organic or inorganic core, or block copolymers. Examples are:

solid rubbers such as styrene-butadiene rubbers and nitrile-butadiene rubbers or polystyrene polymers such as for example SBS block copolymers, polybutadiene, styrene-butadiene rubber, butadiene-acrylonitrile rubber, EPDM, synthetic or natural isoprene rubber, butyl rubber or polyurethane rubber. Partly crosslinked solid rubbers based on isoprene-acrylonitrile or butadiene-acrylonitrile copolymers, epoxy-polyurethane hybrids, polyurethanes derived from hydroxyl-terminated polyoxyalkylenes, such as for example polypropylene glycol or polytetrahydrofuran diol, styrene-butadiene-methyl methacrylate block copolymers, methyl methacrylate-butadiene-methyl methacrylate block copolymers and butadiene-methyl methacrylate block copolymers, and thermoplastic unreactive polyurethane preferably selected from polyurethanes containing a polyester chain are particularly suitable.

In addition to or in place of the aforementioned polymers and block copolymers, the preparation according to the invention can contain rubber particles as impact promoters. These likewise contribute to improving the impact strength of the cured preparation, in particular at temperatures below 0° C. These rubber particles preferably have a core-shell structure. It is preferable here for the rubber particles having a core-shell structure to have a core made from a polymer material having a glass transition temperature of less than 0° C. and a shell made from a polymer material having a glass transition temperature of greater than 25° C. Particularly suitable rubber particles having a core-shell structure can have a core made from a diene homopolymer, a diene copolymer or a polysiloxane elastomer and/or a shell made from an alkyl(meth)acrylate homopolymer or copolymer.

The preparation according to the invention can furthermore contain as impact promoters inorganic particles having a shell made from organic polymers, the organic polymers preferably being selected from polystyrene or from homo- or copolymers of acrylic acid and/or methacrylic acid.

The preparation for use according to the invention can furthermore contain 0 to 30 wt. %, preferably 1 to 20 wt. % of inorganic fillers, such as for example the various ground or precipitated chalks, carbon black, calcium magnesium carbonates, barytes and in particular siliceous fillers of the aluminum magnesium calcium silicate type, for example wollastonite, chlorite. Pyrogenic silicas, bentonites or fibrillated or pulp chopped fibers for example can be added as rheology aids in the range between 0.1 and 5%. Their addition can in particular help to ensure that the CO₂ that was formed is held as gas bubbles in the preparation as it cures.

For the purposes of weight reduction the compositions can contain, in addition to or in place of the aforementioned “normal” fillers, lightweight fillers, which can be selected for example from the group of hollow metal beads such as for example hollow steel beads, hollow glass beads, fly ash (Fillite), hollow plastic beads based on phenolic resins, epoxy resins or polyesters, expanded hollow microbeads with wall material made from (meth)acrylic acid ester copolymers, polystyrene, styrene (meth)acrylate copolymers and in particular polyvinylidene chloride as well as copolymers of vinylidene chloride with acrylonitrile and/or (meth)acrylic acid esters, hollow ceramic beads or organic lightweight fillers of natural origin such as ground nut shells, for example the shells of cashew nuts, coconuts or peanut shells as well as cork meal or coke powder.

Further auxiliary agents and active ingredients can additionally be included, such as for example flexibilizing agents, adhesion promoters, further fillers, pigments and flame retardants, wherein the latter can be particularly important for applications in aircraft construction.

In the case of two-component systems in particular, expansion and/or curing can be accelerated if the preparation contains accelerators for the release of CO₂ from the carbamates. Examples of these are acids, in particular organic acids such as for example lactic acid, citric acid, tartaric acid, etc. Sulfonic acids or phosphonic acids are likewise suitable. The acid is preferably used in hypostoichiometric amounts relative to the total amount of CO₂ to be released.

For the method according to the invention it is preferable for the preparation to contain the following constituents, the stated amounts in wt. % being relative to the total weight of the preparation:

0 wt. % to 90 wt. %, preferably 5 wt. % to 80 wt. % and in particular 20 wt. % to 80 wt. % of epoxy prepolymer that is solid or waxy at 22° C.,
5 wt. % to 90 wt. %, preferably 20 wt. % to 80 wt. % of epoxy prepolymer that is liquid at 22° C.,
5 wt. % to 95 wt. %, preferably 10 wt. % to 60 wt. % of organic ammonium carbamate,
0 wt. % to 90 wt %, preferably 1 wt. % to 60 wt. % of free amine,
0 wt. % to 70 wt. %, preferably 1 wt. % to 50 wt. % of impact promoters,
0 to 30 wt. %, preferably 1 to 20 wt. % of inorganic filler,
wherein the sum of these constituents does not exceed 100 wt. % and wherein a residue can consist to 100 wt. % of further auxiliary agents and active ingredients, in particular flexibilizing agents, release accelerators, adhesion promoters, further fillers, pigments, and flame retardants.

As mentioned above, the preparation can be in one-component or two-component form. In the case of two-component preparations, one component contains the epoxy prepolymers, the other component the ammonium carbamate to accelerate curing, optionally in combination with the free amine, or alternatively one component contains the epoxy prepolymers and the ammonium carbamate and the other component a free amine. Other combinations are also possible, such as for example an embodiment in which epoxy prepolymers and carbamate salt(s) are present in one component and a mixture of free amine and carbamate salt(s) in the second component.

In both embodiments (one-component and two-component) ammonium carbamates can be used that release CO₂ even at ambient temperature (15 to 25° C.). Before the constituents of the preparation are mixed together, these must be stored at a temperature below the release temperature. In the case of one-component preparations, carbamates are preferably used that release CO₂ only at a temperature above the cited ambient temperature, for example above 30° C. or above 40° C. For safety's sake it is nevertheless preferable to store even these one-component preparations before use at a temperature below 15° C., preferably below 10° C. and in particular below 0° C.

Regardless of whether the preparation is used in one-component or two-component form, it is preferable for it to contain both epoxy prepolymer that is liquid at 22° C. and epoxy prepolymer that is solid or waxy at 22° C. The amounts thereof, relative to the complete preparation, are then preferably in the range between 25 and 40 wt. %.

A suitable preparation that is preferably in one-component form can contain for example:

epoxy prepolymer that is liquid at 22° C.,

epoxy prepolymer that is solid at 22° C.,

organic ammonium carbamate based on trimethylolpropane polyoxypropylene triamine (molar mass before carbamate formation: 400); degree of CO₂ loading: 44% of primary amino groups, corresponding to 6.6 wt. % relative to the trifunctional free amine,

fillers, in particular lightweight fillers such as for example hollow glass beads,

rheology aids such as for example pyrogenic silica.

In this case the preferred quantity ranges are:

epoxy prepolymer that is liquid at 22° C.: 25 to 40 wt. %,

epoxy prepolymer that is solid at 22° C.: 25 to 40 wt. %,

organic ammonium carbamate: 10 to 30 wt. %,

fillers, in particular lightweight fillers such as for example hollow glass beads: 5 to 20 wt. %,

rheology aids such as for example pyrogenic silica: 1 to 10 wt. %.

In a preferred embodiment the preparation consists exclusively of the aforementioned five components. In this case the individual amounts should be adjusted to one another so that they add to 100 wt. %. In a further preferred embodiment the preparation also contains in addition to the aforementioned five components flame retardants, preferably in an amount from 0.1 to 60 wt. % relative to the complete composition. Examples are: red phosphorus, which can preferably be used in the quantity range from 0.1 to 5 wt. %, or aluminum hydroxide in a larger quantity, for example in the range from 20 to 60 wt. %.

In a preferred embodiment, before the insert is inserted into the substrate having a hollow structure a hole is made in the substrate, into which the preparation (which is then preferably in waxy or in kneadable form) is pressed and then the insert is pressed into this preparation. Then the preparation is cured. If a one-component preparation is used, the substrate can be stored temporarily for a time (several hours or days, and longer if kept cool) following introduction of the preparation before the insert is inserted and the preparation is cured.

In a further preferred embodiment at least the part of the insert that is to be fixed in the substrate having a hollow structure is at least partly surrounded by the preparation in one- or two-component form. In this case the preparation should be at least solid enough that it is not wiped off when the insert is inserted into the substrate. In this embodiment the inserts can be provided with the preparation by the manufacturer and dispatched in this form. There is then no need for the user to manipulate the preparation at the location at which the insert is inserted into the substrate. Time savings and process simplifications can be achieved in this way. If a two-component preparation is used for this purpose, it can optionally be necessary to store the coated insert at low temperature (below 0° C.) to prevent a premature curing and expansion reaction.

Extrusion or injection methods for example are suitable for surrounding the inserts with the preparation. For example, the insert can be placed in a suitable injection mold and encapsulated therein by injection molding with the preparation to the required extent.

As already mentioned above, the insert is preferably a threaded sleeve with or without an internal thread or a part containing such a sleeve. Other inserts can however also be used, such as for example drive-in nuts or flange nuts. Further elements can then be fixed into these. Inserts such as threaded rods, hooks, screws, sleeves, etc. can however also be anchored directly in the preparation.

In a further aspect the present invention relates to an insert for fixing in a substrate, the part of which to be fixed inside the substrate being at least partly surrounded by an expandable and curable preparation based on an epoxy resin, which preparation cures by being heated to a temperature in the range from 20° C. to 100° C. or above, preferably up to 80° C. and in particular up to 65° C., while being expanded, wherein the preparation contains at least the following components:
a) at least one epoxy resin prepolymer having reactive epoxy groups,
b) at least one organic ammonium carbamate which releases CO₂ at a temperature in the range from 20 to 100° C. or above, preferably up to 80° C. and in particular up to 65° C.

As mentioned above, this insert can be used for inserting in a substrate having a hollow structure. It can be produced in the manner described above. For the preferred composition of the preparation, the above statements about the preparation in the context of the method according to the invention apply accordingly.

The present invention also encompasses an object containing or consisting of a substrate having a hollow structure, wherein the substrate having a hollow structure was reinforced or provided with an insert by the method described above. This object can for example be a component of a ship or an aircraft, in particular a component for overhead compartments in aircraft. It can however also be in general a part for water, land or aircraft or an object in daily use.

The present invention leads to the following advantages:

1.) Lower density than the non-expanded system;
2.) Volume independence or dosing tolerance and compensation for differences in the hole volume;
3.) Possibility of adapting a workpiece to different intentionally produced hole sizes;
4.) Simplified process control and reduced pollution in comparison with the currently conventional use of two-component systems in the preferred area of application.

### EMBODIMENT EXAMPLE

The production of carbamates is known from the literature, for example from the documents U.S. Pat. No. 3,425,964 and U.S. Pat. No. 3,320,187 cited in the introduction.

A preparation with the following composition was produced by mixing the components listed below (in wt. % relative to the complete composition):

epoxy prepolymer that is liquid at 22° C.: 33.5 wt. %,

epoxy prepolymer that is solid at 22° C.: 33.5 wt. %,

organic ammonium carbamate based on trimethyloipropane polyoxypropylene triamine (molar mass before carbamate formation: 400; degree of CO₂ loading: 44% of primary amino groups, corresponding to 6.6 wt. % relative to the free amine): 20 wt. %,

hollow glass beads: 10 wt. %,

pyrogenic silica: 3 wt. %.

This preparation was molded at room temperature (22° C.) into a cylindrical part weighing 0.3 g. This cylindrical part was inserted into a hole in a phenolic resin sheet having a honeycomb sandwich structure, coated with glass fiber phenolic resin prepreg. An insert in the form of a threaded sleeve having an internal thread was inserted into this preparation. This threaded sleeve consisted of a round top part with a diameter of 11 mm and a height of 1 mm, a cylindrical shaft with a height of 4 mm and a diameter of 7 mm, and a largely rectangular base plate, rounded on the short side, with a length of 11 mm, a width of 7 mm and a height of 1 mm. This insert was pressed into the composition as far as the top edge of the top part. Then it was heated to a temperature of 60° C. for one hour for the purposes of expansion and curing. After being stored for 7 days at 22° C., the tensile force needed to pull the insert out of the substrate was measured. To this end the substrate was held by a retaining plate having a hole somewhat larger than the diameter of the top part of the insert. The top part was connected to a tensile testing machine (Zwick Z050) and pulled out at a drawing speed of 0.1 mm/sec. A tensile force of 470 N was determined for removing the insert. The fracture behavior was cohesive.

1. A method for reinforcing a substrate having a hollow structure, wherein an expandable and curable preparation based on epoxy resin is introduced into a selected part of the hollow structure to be reinforced, and the preparation cures by being heated to a temperature in the range from 20° C. to 100° C. or above, preferably up to 80° C. and in particular up to 65° C., while being expanded, wherein the preparation contains at least the following components:
a) at least one epoxy resin prepolymer having reactive epoxy groups,
b) at least one organic ammonium carbamate comprising at least one carbamate anion and at least one organic ammonium counterion.

2. A method for fixing an insert in a substrate having a hollow structure, wherein an expandable and curable preparation based on epoxy resin is introduced into a selected part of the hollow structure in which the insert is to be fixed, the insert is introduced into the same part of the hollow structure such that the part of the insert to be fixed inside the hollow structure dips into the expandable and curable preparation before or after it is expanded and cured, and the preparation cures by being heated to a temperature in the range from 20° C. to 100° C. or above, preferably up to 80° C. and in particular up to 65° C., while being expanded, wherein the preparation contains at least the following components:
a) at least one epoxy resin prepolymer having reactive epoxy groups,
b) at least one organic ammonium carbamate comprising at least one carbamate anion and at least one organic ammonium counterion.

3.-13. (canceled)

14. An insert for fixing in a substrate, the part of which to be fixed inside the substrate being at least partly surrounded by an expandable and curable preparation based on an epoxy resin, which preparation cures by being heated to a temperature in the range from 20° C. to 100° C. or above, preferably up to 80° C. and in particular up to 65° C., while being expanded, wherein the preparation contains at least the following components:
a) at least one epoxy resin prepolymer having reactive epoxy groups,
b) at least one organic ammonium carbamate comprising at least one carbamate anion and at least one organic ammonium counterion and that releases CO2 at a temperature in the range from 20 to 100° C. or above, preferably up to 80° C. and in particular up to 65° C.

15. (canceled)
